(19) United States
(12) Patent Application Publication
(10) Pub. No.: US 2003/0227377 A1
(43) Pub. Date: Dec. 11, 2003

(54) Wireless security notification and control system

(76) Inventor: Zaid Roberto C. Cardenas, Tijuana (MX)

Correspondence Address: CHARMASSON & BUCHACA, 1545 HOTEL CIRCLE SOUTH, SUITE 150, SAN DIEGO, CA, 92108-3412, US

(21) Appl. No.: 10/458,876

(22) Filed: Jun. 10, 2003

Related U.S. Application Data
(60) Provisional application No. 60/388,149, filed on Jun. 10, 2002.

(51) Int. Cl. B60R 25/10

(52) U.S. Cl. 340/426.11

(57) ABSTRACT

A vehicle security system uses a local cellular phone handset or other type of phone station and components of a conventional car alarm apparatus to call a remote phone station upon detection of an unauthorized entry. The system also responds to the ringing of the phone handset and disables the vehicle by cutting the electrical supply to the engine. The system can be used in a variety of settings to respond to an emergency condition and to remotely deactivate other types of electromechanical device.

### PRIOR APPLICATION

This is a continuation-in-part of provisional application Serial No. 60/388,149 filed Jun. 10, 2002.

### FIELD OF THE INVENTION

This invention relates to alarm and security systems, and more particularly to automotive intrusion detectors and engine disabling equipment.

### BACKGROUND OF THE INVENTION

Conventional car anti-theft devices which, upon detection of an intrusion or misuse of the vehicle, momentarily sound an alarm and flash the parking lights are grossly inadequate to prevent illegal entry and theft of the vehicle.

The instant invention results from an attempt at improving the efficiency of vehicular anti-theft equipment by transmitting an early warning of the intrusion to the owner of the vehicle and giving that person the ability to remotely disable the operation of the car engine.

### SUMMARY OF THE INVENTION

The principal and secondary objects of this invention are to provide an effective anti-theft system for vehicles which, not only transmit via telephone, a warning signal to the owner upon breaking of the car security, but also allows the owner to call the car and disable the engine.

These and other valuable objects are achieved by using a portable cellular telephone handset combined with the components of a conventional car alarm system to automatically dial a preset phone number upon unauthorized intrusion into the vehicle or other emergency condition, and sensing a ringing signal on the cellular phone handset, to cut off the electrical supply to the vehicle engine. In a first instance, the handset or. other type of telephone terminal is activated by the emergency condition detector and automatically calls a pre-programmed remote telephone station.

### BRIEF DESCRIPTION OF THE DRAWING

FIG. 1 is a block diagram of a wireless vehicular security system according to the invention;

FIG. 2 is a wiring diagram of the cellular phone calling circuits;

FIG. 3 is a wiring diagram of the remote engine disabling system; and

FIG. 4 is a block diagram of an alternate embodiment of the remote engine-disabling system.

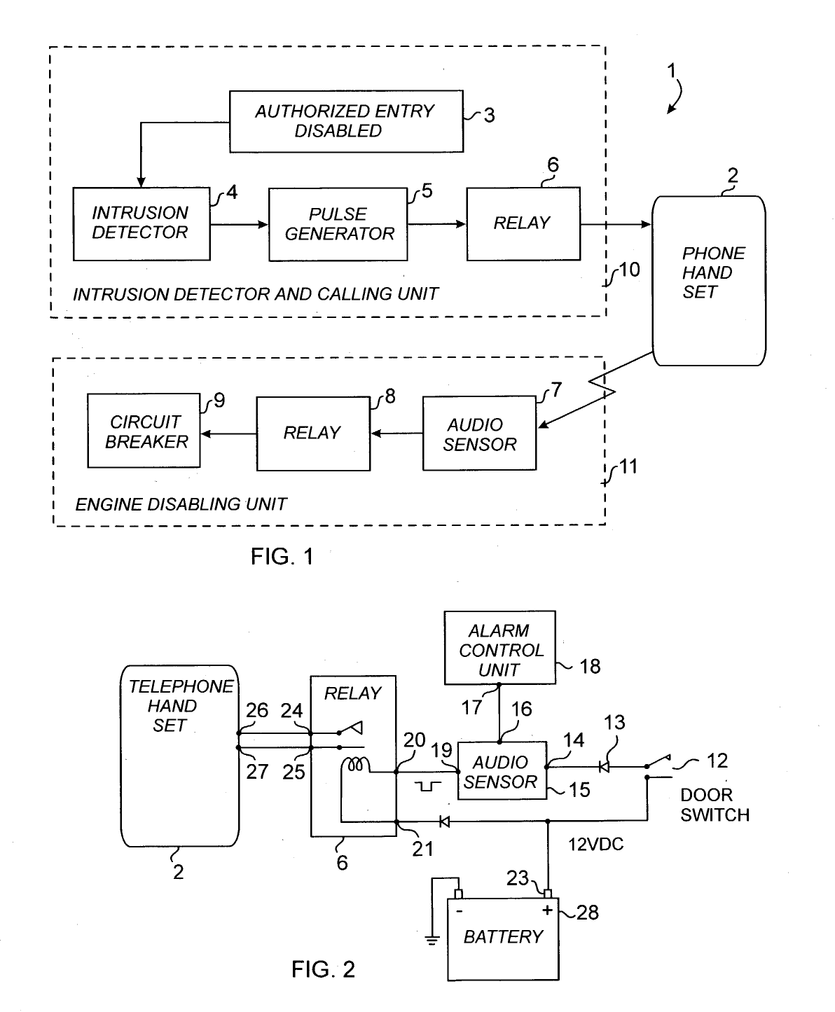

### DESCRIPTION OF THE PREFERRED EMBODIMENT OF THE INVENTION

Referring now to the drawing, there is illustrated a relatively simply, easy to install, and efficient car security system 1 composed of a conventional cellular handset 2 and various components 3-9 of a conventional car alarm system.

The system is divided into two parts, namely, an intrusion detection and remote calling unit 10 and a remotely or locally activated engine disabling unit 11. Both units share the same cellular phone handset 2 such as Model V2390 sold under the MOTOROLA brand name. Upon detection of an intrusion by some conventional detector circuits 4 such as a door switch, motion detector or sound detector, a pulse generator 5 momentarily activates a relay 6. Normally, open contact terminals of the relays are wired in parallels to the terminal of a “CALL” button on the cellular telephone handset 2. The handset has been preprogrammed to call the phone station of the owner or a security agency. The intrusion detector is controlled by a conventional vehicular alarm circuitry 3 that can be remotely disabled by the approaching legitimate owner of the vehicle using a conventional, keyring infrared remote control unit.

In the remotely controlled engine-disabling unit 11, the audio sensor 7, upon hearing the ringing of the cellular handset 2, activates a relay whose closure activates another relay acting as an engine circuit breaker 9.

As more specifically illustrated in FIG. 2, the terminal of the vehicle driver's door switch 12 is connected through a diode 13 to the positive supply terminal 14 of a conventional car alarm audio sensor 15 such as Model GS-100B sold under the PROTEC brand name. The door switch 12 is wired to apply a positive 12-volt to the audio sensor terminal 14 when the door is opened. The negative power supply terminal 16 of the audio sensor is connected to one of the output terminals 17 of a conventional vehicular alarm control unit 18 such as Model M3 sold under the MARKSMAN brand name. The terminal 17 is one that supplies a negative or grounding signal when the alarm control unit is enabled when the car door is locked by the authorized operator. The audio sensor 15 generates and delivers on its output terminal 19 a ground or negative pulse upon detection of the slightest noise while the door is opened. That output terminal 19 of the audio sensor is wired to one of the energizing coil terminals 20 of the relay 6, the other coil terminal 21 is connected by another diode 22 to the positive terminal of the vehicle battery 23. Accordingly, upon detection of an illegal entry manifested by the opening of the door and the detection of a slight noise, the relay is energized and a closure is provided between the normally open contact terminals 24, 25, those two terminals are wired in parallel with the terminals 26, 27 of the “SEND” pushbutton on the cellular telephone handset 2.

It should be understood that the above-described silent alarm apparatus may be complemented by a conventional siren alarm system operating from the same door switch and audio sensor.

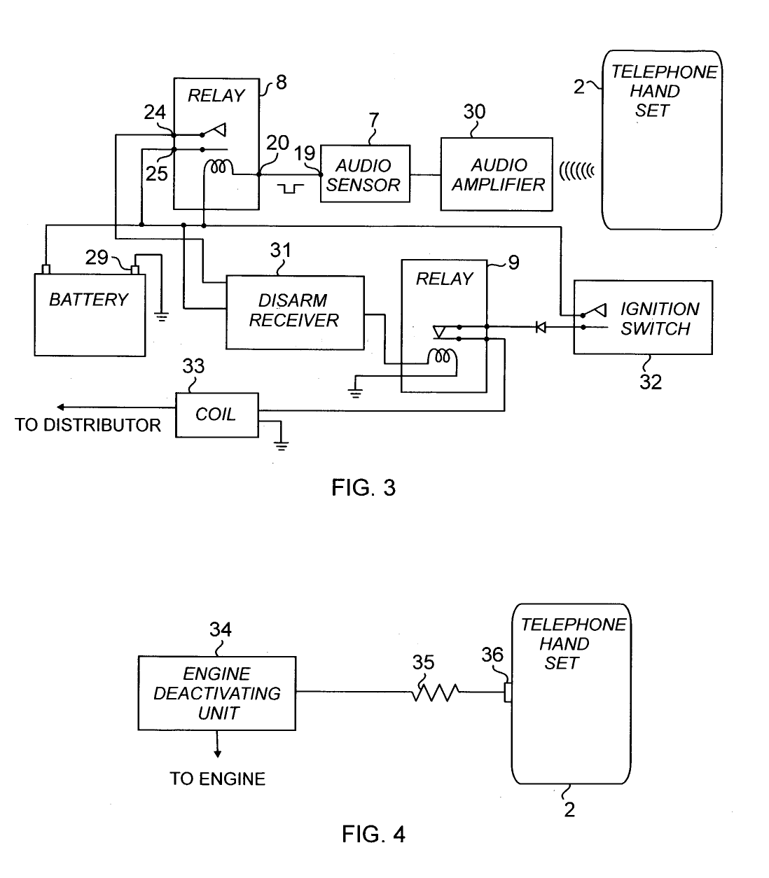

As more specifically illustrated in FIG. 3, in the automotive remote engine disabling unit 11, the same audio detector 7 used in the intrusion detector and calling unit 10 is positioned to sense the ringing of the telephone handset 2. An audio focusing and amplifying unit 30 is preferably used between the handset 2 and the sensor 7 for more effective and reliable operation. The same negative pulse output 19 that was used in the intrusion detector and calling unit 10 to activate the relay 6 is also used in a similar manner to activate another relay 8. The normally open contact terminals 24, 25 of the relay are used to activate another relay acting as a circuit breaker between the ignition switch 32 and the distribution coil 33.

Accordingly, when the telephone handset rings, the audio detector energizes the relays which upon closure causes the circuit breaker 9 to trip and to cut the supply of power to the engine power distribution circuit.

The supply to the coil of the relay 9 is controlled by a receiver 31 of the type used in connection with car security systems. The receiver can be remotely addressed by the legitimate owner to cut the power for the relay and, thus, disarm the engine disabling unit. In other words, the power is allowed to flow from the ignition switch to the coil through the normally closed contact of the circuit breaker relay 9.

Illustrated in FIG. 4 is an alternate embodiment of the engine disabling system. This system is built around an engine deactivating unit 34 of the type commercdially available under the generic name of anti-assault module such as Model AS-1000 sold under the PROTEC brand name. This unit connects to the electrical circuit of the car engine and has the-capability of disabling critical engine function upon receipt from the telephone handset 2 of a signal appearing on a terminal 36 when the phone rings. A current limiting resistor 35 is interposed between the handset and the engine deactivating unit.

It should be noted that the application of the above-described invention is not limited to vehicle security but can be extended to protect other mobile as well as immobile structures and to answering a variety of emergency conditions, or to remotely disable a variety of electro-mechanical devices in response to a telephone call.

While the preferred embodiments of the invention have been described, modifications can be made and other embodiments may be devised without departing from the spirit of the invention and the scope of the appended claims.

What is claimed is:

1. A remote silent alarm apparatus which comprises:
a local telephone station;
means for detecting an emergency condition;
means, responsive to said means for detecting, for causing the local telephone station to dial a remote telephone station;
means for sensing a call signal to said local telephone station; and
means for disabling an electromechanical device.

2. The apparatus of claim 1, wherein said local telephone station comprises a portable cellular phone handset.

3. The apparatus of claim 1, wherein said means for detecting comprise an audio sensor.

4. The apparatus of claim 3, wherein said means for causing comprise:
a relay having an energizing coil connected to said audio sensor, and contact terminals connected to said local telephone station.

5. The apparatus of claim 3, wherein said means for detecting comprise a door switch.

6. The apparatus of claim 1, wherein said means for disabling comprise means responsive to said means for sensing.

7. The apparatus of claim 1, wherein said means for disabling comprise means responsive to said means for detecting.

8. The apparatus of claim 1, wherein said means for disabling comprise a relay.

9. The apparatus of claim q1, wherein said means for disabling comprise an automotive engine deactivating unit.

10. The apparatus of claim 9 in combination with a vehicle including said engine.

11. The apparatus of claim 1, wherein said means for detecting comprise a car alarm audio sensor.

12. The apparatus of claim 2, wherein said means for disabling comprise means responsive to said means for detecting and to said means for sensing; and
further comprise an automotive engine deactivating unit.
